(19) United States
(12) Patent Application Publication
(10) Pub. No.: US 2005/0247722 A1
(43) Pub. Date: Nov. 10, 2005

(54) Band-aid dispenser / first-aid kit

(76) Inventor: Andre Demond Blocker, Altamonte Springs, FL (US)

Correspondence Address: Andre Demond Blocker, Apt 209, 823 Camargo Way, Altamonte Springs, FL, 32714, US

(21) Appl. No.: 11/103,012

(22) Filed: Apr. 11, 2005

Related U.S. Application Data
(60) Provisional application No. 60/568,378, filed on May 5, 2004.

(51) Int. Cl. B65G 59/00

(52) U.S. Cl. 221/119; 602/1

(57) ABSTRACT

A Band-Aid Dispenser for Band-Aids is disclosed. The Dispenser compromises a rectangle shaped body with an option on the commercial Dispensers to have a First-Aid kit on top. The Dispenser can still be removed and replaced as needed, inside the Dispenser are three sections, each containing Band-Aid spools of small, medium and large. Each are dispensed through the slots in the front for easy access to the Band-Aids and then are easily torn off for usage. These Dispensers can be mounted anywhere for easy access with or without a First-Aid kit.

### DESCRIPTION OF THE PRIOR ART

People often get cuts and have to deal with the hassle of taking a Bandage out of its wrapper. We also have to deal with the frustration of finding the correct size Bandage for a particular wound. In the commercial area, management often deal with the frustration of theft of Bandages and abused usage of them. We often run into the problem of finding all of the bandages have been depleted at the last minute. Although several dispensers have been developed to assist a user for easier access to a Bandage, they are structurally complex and limited to just a dispenser. The present invention solves the above enumerated problems by providing a dispenser assembly having a uniquely configured dispensing system with option of First-Aid. Various dispensers and similar spools for dispensers exist in the prior art. For an example U.S. Pat. No. 5,065,894 issued to Garland discloses a dispenser with one size of Bandages still in paper Bandage dispensed side ways.

U.S. Pat. No. 6,662,967 issued to Roy discloses a dispenser of Bandages of three different sizes all still in the wrappers not on rolls.

U.S. Pat. No. 3,530,494 issued to Baratta discloses a dispenser with a spool of Bandages still wrapped only one size on a roll.

U.S. Pat. No. 5,358,140 issued to Pellegrino discloses a dispenser not on rolls with Bandages still covered.

U.S. Pat. No. 6,299,018 issued to Kimbrell discloses a dispensing gun with one size Bandage still in paper on a roll.

U.S. Pat. No. 4,993,586 issued to Taulbee et al. discloses a dispenser with a spool of Bandages one size still in paper using a big and bulky Dispenser.

U.S. Pat. No. 4,807,753 issued to Goldstein discloses a dispenser with three different size Bandages on rolls with Bandages still wrapped in paper.

The present invention provides a unique Dispenser option having the Bandages easily used with no hassle and or First-aid kit option. It also has the option (on the commercial Dispenser) to lock the spools away to prevent theft.

### BACKGROUND OF THE INVENTION

The present invention relates to a Band-Aid Dispenser with optional First-Aid kit. This invention allows any one to treat a wound immediately without any hassles. This invention also keep Bandages form being stolen or abused usage from occurring.

### BRIEF SUMMARY OF THE INVENTION

This invention is a Band-Aid Dispenser kit with optional First-Aid kit. It contains three rolls of Band-Aids on spools, that are on a track. The Band-Aids feed through the front of the kit where they are easily snapped off with the help of cutters. The spools of Band-Aids have perforated edges for easy and correct length tearing of Band-Aids.

The Dispenser is rectangle in shape with all sides enclosed to protect the Band-Aids from germs. In the commercial Dispenser just above the Dispenser lies the First-Aid kit, which is divided into three compartments that is covered with a top lid. It consists of all essential products in a standard First-Aid kit. The Dispenser contains a lock on the side that prevent theft of Bandages. Band-Aid spools can easily be replaced by sliding the old spools out and replacing with the new spool, this new Dispenser is different from the current Dispensers on the market. It has all the materials on the top compartment with all of the Band-Aids below on the spool. You do not have to open anything to get a Band-Aid anymore.

If someone wanted to use it, the process would be simple. To get a Band-Aid you would choose a size and pull it until the perforated edge lines up with the cutter, then just snap off the Band-Aid and apply to the wound. If you need any other First-Aid products, just open up the top lid and remove the item.

### BRIEF DESCRIPTIONS OF THE DRAWINGS

FIG. 1 is a perspective view of the commercial Band-Aid Dispenser with optional First-Aid kit.

FIG. 2 is the front view of the commercial Band-Aid Dispenser only (X-Rayed View)

FIG. 3 is the side view of the commercial band-Aid Dispenser only (X-Rayed view)

FIG. 4 is the front view of the residential Band-Aid Dispenser

FIG. 5 is the side view of the residential Dispenser (X-Rayed view)

### DESCRIPTION OF THE PREFERRED EMBODIMENT

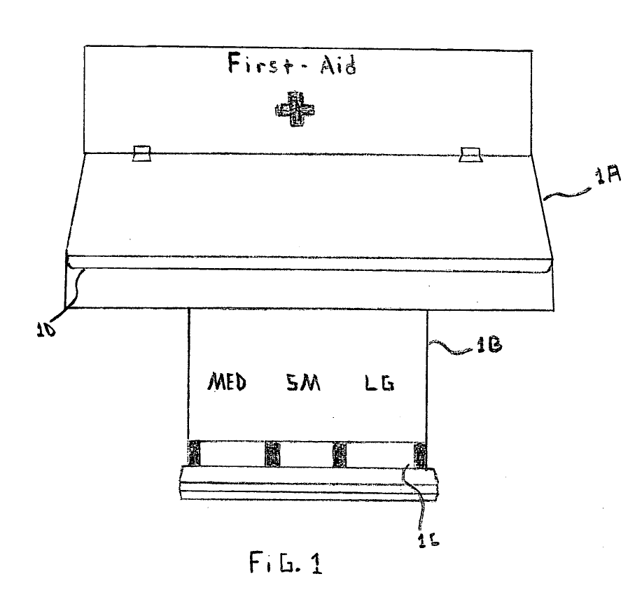

Referring, now to FIG. 1 the present invention relates to a Band-Aid Dispenser with optional First-Aid kit on the commercial Dispenser. The Dispenser on the commercial one is locked on the side so that the Bandages can't be stolen.

FIG. 1A. Is the (optional) commercial First-Aid kit

FIG. 1B. Is the Band-Aid Dispenser

FIG. 1C. Are the chambers that the spools set in and are dispensed from

FIG. 1D. The First-Aid kit top lid

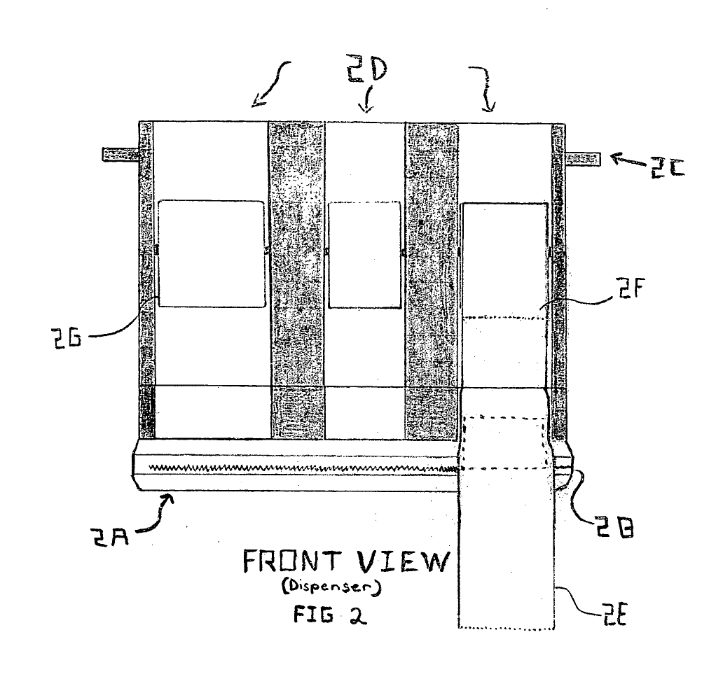

Referring now to FIG. 2, which is the commercial Dispenser alone. Showing the front view of the Dispenser. (X-rayed view)

FIG. 2A. Shows the Band-Aid resting base

FIG. 2B. Shows the Band-Aid cutters

FIG. 2C. Clearly shows the Dispenser supports for the mounting of the

Dispenser by sliding it on and off the First-Aid kit's track.

FIG. 2D. Are the sections that each size spool sit in. Small, med and large

FIG. 2E. Is showing the back of the Band-Aid strip

FIG. 2F. Is showing the perforated area on the Band-aid strip

FIG. 2G. Is showing the Band-Aid spool

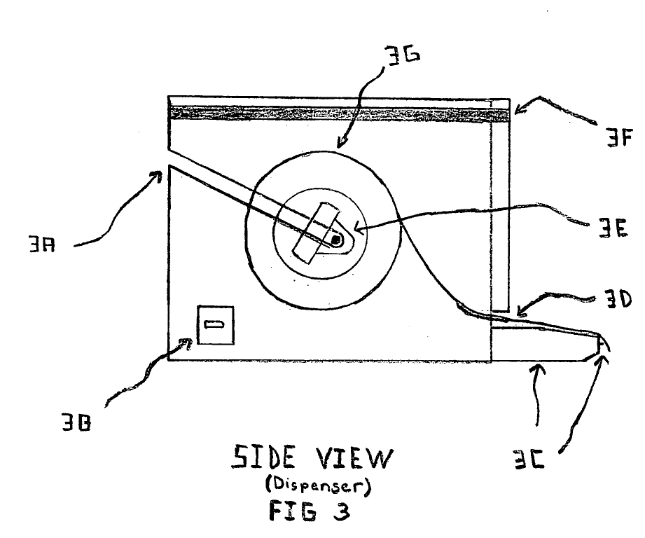

Referring now to FIG. 3, is now showing the side view of the commercial Dispenser.

FIG. 3A. Is showing the track or groove that the spools slide down into place for each individual spool.

FIG. 3B. Is showing the latch that the lock is secured to lock away the bandages.

FIG. 3C. Is again showing the Band-Aids resting base with the cutters on the front.

FIG. 3D. Showing the perforated Band-Aid

FIG. 3E. Is showing the spool support

FIG. 3F. The Dispenser supports for mounting (side view)

FIG. 3G. The Band-Aid spool

Referring now to FIG. 4, is showing the residential Dispenser (front view)

FIG. 4A. The opening for the bandage to feed through

FIG. 4B. The Band-Aid resting base with cutter made of lite weight plastic material.

FIG. 4C. The residential Dispenser, made of lite weight plastic or cardboard material with assorted colors.

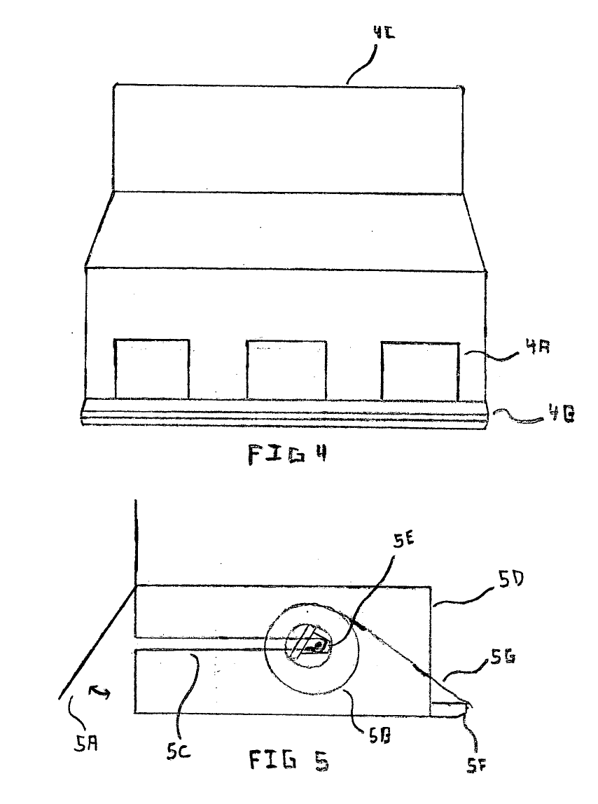

Referring now to FIG. 5 is now showing the residential Dispenser's side view. (X-Rayed)

FIG. 5A. The rear service door to access the spools

FIG. 5B. Band-Aid spool

FIG. 5C. Spool track or groove

FIG. 5D. Dispenser housing

FIG. 5E. The spool support

FIG. 5F. Band-Aid resting base

FIG. 5G. Band-Aid

### A Statement on the Corrected Specification

The corrected Specification for U.S. application Ser. No. 11/103,012 line spacing was corrected. This Specification contains no new matter. It now contains 12 pages compared to the last specification of 9 pages. The following titles have been corrected and sent back for examination.

1. Description of the prior art

2. Background of the invention

3. Brief summary of the invention

4. Brief description of the drawings

5. Description of the preferred embodiment

6. Claims

7. References Cited

8. Abstract

REFERENCES CITED
U.S. PATENT DOCUMENTS

| | | |
|---|---|---|
| 3,530,494 | 9/1970 | Baratta |
| 4,807,753 | 2/1989 | Goldstein |
| 4,993,586 | 4/1991 | Taulbee et al |
| 5,065,894 | 11/1991 | Garland |
| 5,358,140 | 10/1994 | Pellegrino |
| 6,299,018 | 10/2001 | Kimbrell |
| 6,662,967 | 12/2003 | Roy |

1. A Dispenser with spools of Band-Aids on rolls, compromising a round shape with three different sizes of Band-Aids, (small, medium and large) and all different colors of Bandages. Each roll could hold Seventy-Five to One Hundred individual Band-Aids that are individually perforated for a correct and accurate tare of a Band-aid.

2. A Rectangle shaped Dispenser body incasing three different sizes of Band-Aid spools. (Small, medium and large) The spools slide into the Dispenser on a track or groove in the dispenser unit. The unit is enclosed on all sides even on the top to protect the Bandages from collecting Dirt, Germs and Bacteria. The unit also has three small openings in front so that the Bandages can be fed through the slots for easy access to them. On the commercial Dispenser it will be attached to the bottom of an optional First-Aid kit, which could be attached by sliding the unit on the tracks that are located on the bottom of the First-Aid kit that holds it secure. The commercial Dispenser is made of plastic. On the residential unit, the Dispenser can stand-alone and be made up of durable cardboard material.

3. The Dispensing unit has a lock so that the bandages can't be stolen. The lock is located on the side of the unit; it can only be accessed by authorized personnel with the key.
